(19) United States
(12) Patent Application Publication
(10) Pub. No.: US 2022/0130005 A1
(43) Pub. Date: Apr. 28, 2022

(54) DIGITAL ASSET MANAGEMENT SYSTEMS AND METHODS

(71) Applicant: ROXE HOLDING INC., Jersey City, NJ (US)

(72) Inventor: Maodong XU, New York, NY (US)

(21) Appl. No.: 17/310,423

(22) PCT Filed: Jan. 31, 2020
(86) PCT No.: PCT/IB2020/050776

§ 371 Date: Aug. 2, 2021

Related U.S. Application Data
(60) Provisional application No. 62/799,664, filed on Jan. 31, 2019.
(60) Provisional application No. 62/799,659, filed on Jan. 31, 2019.

(51) Int. Cl. G06Q 50/18

(52) U.S. Cl. CPC G06Q 50/18

(57) ABSTRACT

A system (100) including a merchant system (110) and client system (120) to perform a computer implemented method (800) comprising: receiving (801) one or more parameters of a contract; generating (803) a smart contract representing the contract in accordance with the one or more parameters; recording (805) the smart contract on a distributed ledger (140); receiving (811) a request for a contract token; and issuing (813) the contract token in accordance with the smart contract, wherein the contract token is associated with a merchant, and wherein the one or more parameters are specified by the merchant.

### CROSS-REFERENCE TO RELATED APPLICATIONS

The present application claims priority from U.S. Provisional Patent Application No. 62/799,659 filed on 31 Jan. 2019, and U.S. Provisional Patent Application No. 62/799,664 filed on 31 Jan. 2019, the contents of which are incorporated herein by reference in their entirety.

### TECHNICAL FIELD

Described embodiments relate to systems, computer-implemented methods and computer programs for digital asset management. In particular, described embodiments relate to managing a contract token associated with a distributed ledger.

### BACKGROUND

The development of sophisticated computer hardware and networking technology has facilitated growth of a number of industries utilising widespread adoption of said technology. For example, the Internet, and use thereof has seen significant growth. Initially being a system useable for relatively low-bandwidth applications like text-based data sharing, the Internet now facilitates rapid communication of vast amounts of data.

Two categories of entities utilising the Internet include internet-related service companies providing online services and internet-related service companies providing offline services facilitated by online services. Examples of internet-related service companies providing online services include Google, Facebook, WeChat and Baidu, where delivery of the services is provided almost, or entirely online. Examples of internet-related service companies providing offline services facilitated by online services include Amazon, Uber, Airbnb, Taobao, Jingdong and Xinmeida (Meituan-Dianping). Internet-related service companies providing offline services facilitated by online services can be further divided into at least two categories, the first being stock keeping unit (SKU) centred delivery, such as Amazon, Taobao and Jingdong, and the second being user location centred delivery, such as Uber and Xinmeida.

Providing or offering services relevant to a user is an ongoing challenge for internet-related service companies. Traditional advertising methods can be used (e.g. online advertising, print advertising, television advertising), however they can be poorly optimised when considering consumers location, preferences and/or likely or desired future consumption. Furthermore, consumers seeking products and/or services may not be provided with a convenient way of finding products and/or services of interest.

Entities seeking to raise capital to, for example, fund continued operations, or develop, refine or provide a product or service may seek capital from a number of sources using a number of methods. The entities can source capital from Angel investors, Venture Capital firms and/or members of the public, for example. Entities can raise capital using one or more of a number of methods including loans or executing an Initial Public Offering (IPO). An IPO is a public offering of entity stock which may be sold to institutional investors or members of the public. The stock is typically listed on one or more Stock Exchanges or trading markets.

Traditional methods of raising capital can incur significant burden on the entity, or the owner(s) of the entity. For example, interest and/or principal repayments of loans can place financial strain on the entity, as can the service fees (e.g. legal fees) associated with establishing the loan, and maintaining the loan or updating its terms. Alternatively, executing the IPO can result in a significant dilution in the original owner(s) subsequent ownership and/or voting rights, whilst significantly increasing regulatory burden and public scrutiny of the entity's operations. Furthermore, traditional methods of raising capital can exclude large portions of the population that may wish to participate in the capital raise. For example, in a number of jurisdictions, private capital raises are available only to investors meeting certain criteria, for example, having a net worth exceeding a net worth threshold.

Additional challenges with traditional capital raising include locating and targeting investors interested, knowledgeable and/or willing to invest the capital. Traditional advertising methods can be used (e.g. online advertising, print advertising, television advertising), however they are often poorly optimised when considering investor's location and/or preferences. Furthermore, investors seeking investment opportunities may not be provided with a convenient way of finding investment opportunities of interest.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a computer implemented method comprising: receiving one or more parameters of a contract; generating a smart contract representing the contract in accordance with the one or more parameters; recording the smart contract on a distributed ledger; receiving a request for a contract token; and issuing the contract token in accordance with the smart contract, wherein the contract token is associated with a merchant, and wherein the one or more parameters are specified by the merchant.

In some embodiments, the contract token is associated with one or more location-based condition(s).

In some embodiments, the one or more parameters relate to a number of the contract token to be issued, an issuance time of the contract token, an issuance price of the contract token, a minimum subscription quantity of the contract token at issue and/or a useable unit price of the contract token.

In some embodiments, the contract token is issued in exchange for a transfer of ownership of a unit of account to the merchant at an issuance ratio.

In some embodiments, receiving the request for the contract token comprises the transfer of ownership of the unit of account to the merchant at the issuance ratio.

In some embodiments, receiving the request for the contract token comprises the transfer of ownership of a digital asset to a smart contract address associated with the smart contract recorded on the distributed ledger.

In some embodiments, the issuance ratio corresponds to the ratio between an issuance quantity of the contract token that is issued per base unit of the unit of account at a first time.

In some embodiments, the first time is indexed to the issuance time.

In some embodiments, the first time is the time at which the transfer of ownership of the unit of account to the merchant or the smart contract address is executed.

In some embodiments, the contract token is exchangeable, after issuance, with the merchant at a post-issuance ratio.

In some embodiments, the post-issuance ratio corresponds to an exchangeable quantity of the contract token, the exchangeable quantity being exchangeable with the merchant for goods and/or services valued at the base unit of the unit of account at a second time, the second time being after the first time.

In some embodiments, the issuance ratio is greater than the post-issuance ratio.

In some embodiments, the one or more location-based conditions comprises a restriction on the exchange of the contract token with the merchant at the post-issuance ratio to one or more specified merchant location(s).

In some embodiments, the unit of account is a fiat currency, a digital asset, a financial asset or a real asset.

In some embodiments, at least part of the location-based condition(s) is published on the distributed ledger.

In some embodiments, the distributed ledger is a public distributed ledger, a private distributed ledger, a permissionless distributed ledger and/or a permissioned distributed ledger.

In some embodiments, the steps of receiving one or more parameters of a contract, generating a smart contract representing the contract in accordance with the one or more parameters, and recording the smart contract on a distributed ledger are executed by a merchant system.

Some embodiments relate to a computer-readable storage medium storing instructions that, when executed by a computer, cause the computer to perform the method of any one of the previous statements.

Some embodiments relate to a system comprising: a merchant system associated with a merchant comprising; at least one merchant system processor; and a merchant system memory storing merchant system program code accessible by the at least one merchant system processor, and configured to cause the at least one merchant system processor to: receive one or more parameters characterising of a contract; generate a smart contract representing the contract in accordance with the one or more parameters; and record the smart contract on a distributed ledger; and a client system associated with a client comprising; at least one client system processor; and a client system memory storing client system program code accessible by the at least one client system processor, and configured to cause the at least one client system processor to: generate a request for a contract token; send the request for the contract token the smart contract recorded on the distributed ledger; and receive the contract token issued by the smart contract in accordance with the one or more parameters.

In some embodiments, the contract token is associated with one or more location-based condition(s).

In some embodiments, the one or more parameters relate to a number of the contract token to be issued, an issuance time of the contract token, an issuance price of the contract token, a minimum subscription quantity of the contract token at issue and/or a useable unit price of the contract token.

Some embodiments further comprise a distributed ledger system comprising: at least one distributed ledger system processor; and a distributed ledger system memory storing distributed ledger system program code, the distributed ledger and the smart contract, the smart contract being accessible by the at least one distributed ledger system processor, and configured to cause the at least one distributed ledger system processor to: receive the request for the contract token; and issue the contract token in accordance with the smart contract.

In some embodiments, the contract token is issued in exchange for a transfer of ownership of a unit of account to the merchant at an issuance ratio.

In some embodiments, receiving the request for the contract token comprises the transfer of ownership of the unit of account to the merchant at the issuance ratio.

In some embodiments, receiving the request for the contract token comprises the transfer of ownership of a digital asset to a smart contract address or a merchant wallet address associated with the smart contract recorded on the distributed ledger.

In some embodiments, the issuance ratio corresponds to the ratio between an issuance quantity of the contract token that is issued per base unit of the unit of account at a first time.

In some embodiments, the first time is indexed to the issuance time.

In some embodiments, the first time is the time at which the transfer of ownership of the unit of account to the merchant or the smart contract address is executed.

In some embodiments, the contract token is exchangeable, after issuance, with the merchant at a post-issuance ratio.

In some embodiments, the post-issuance ratio corresponds to an exchangeable quantity of the contract token, the exchangeable quantity being exchangeable with the merchant for goods and/or services valued at the base unit of the unit of account at a second time, the second time being after the first time.

In some embodiments, the issuance ratio is greater than the post-issuance ratio.

In some embodiments, the one or more location-based conditions comprise a restriction on the exchange of the contract token with the merchant at the post-issuance ratio to one or more specified merchant location.

In some embodiments, the unit of account is a fiat currency, a digital asset, a financial asset or a real asset.

In some embodiments, at least part of the location-based condition(s) is published on the distributed ledger.

In some embodiments, the distributed ledger is a public distributed ledger, a private distributed ledger, a permissionless distributed ledger and/or a permissioned distributed ledger.

In some embodiments, the merchant system comprises a merchant system user interface, and wherein the merchant system is configured to receive an input via the merchant system user interface, the input comprising instructions indicative of the one or more parameters.

Some embodiments relate to a client system comprising; at least one client system processor; and a client system memory storing client system program code accessible by the at least one client system processor, and configured to cause the at least one client system processor to: determine a geographic location of the client system; request, from a database, identification of one or more merchants, based on location-based condition(s) of the one or more merchants in the database and the geographic location of the client system; and generate an output, the output providing an indication of the identified one or more merchants.

Some embodiments further comprise a client system user interface, wherein the client system program code is further configured to cause the at least one client system processor to display the output via the client system user interface.

In some embodiments, the client system is configured to receive an input via the client system user interface, the input comprising instructions to execute the request.

In some embodiments, the client system comprises a client system database, and the database is, at least in part, the client system database.

In some embodiments, the database is, at least in part, a merchant system database.

In some embodiments, the database is at least one node of a distributed ledger.

In some embodiments, the client system program code is further configured to cause the at least one client system processor to: generate a request for a contract token; send the request for the contract token to a smart contract or to a secondary trading market; and receive the contract token, wherein the contract token is associated with at least one merchant and one or more parameters specified by the at least one merchant.

Some embodiments further comprise a client system wallet, wherein the client system program code is further configured to cause the at least one client system processor to receive the contract token at the client system wallet.

In some embodiments, receiving the contract token comprises a transfer of ownership of the contract token from a first entity to the client system.

In some embodiments, the client system program code is further configured to cause the at least one client system processor to transfer ownership of the contract token to the merchant during a transaction with the merchant for a good and/or service.

Some embodiments relate to a merchant system comprising: at least one merchant system processor; and a merchant system memory storing merchant system program code accessible by the at least one merchant system processor, and configured to cause the at least one merchant system processor to: receive one or more parameters characterising a contract; generate a smart contract representing the contract in accordance with the one or more parameters; record the smart contract on a distributed ledger to issue one or more contract tokens, associated with the merchant and in accordance with the one or more parameters in the contract; receive, from a client system, a transaction request wherein the transaction request includes a request for provision of a good and/or service from the merchant in exchange for one or more contract token as payment; send, to the client system, a merchant wallet address associated with the merchant to facilitate transfer of ownership of the one or more contract tokens to the merchant; and based on verification that the contract token is transferred to the merchant wallet address, send an authorization to provide the good and/or service for the transaction.

### BRIEF DESCRIPTION OF DRAWINGS

FIG. 1 is a block diagram of a system according to some embodiments;

FIG. 2 is a block diagram of a merchant system according to some embodiments;

FIG. 3 is a block diagram of a merchant system memory according to some embodiments;

FIG. 4 is a block diagram of a client system according to some embodiments;

FIG. 5 is a block diagram of a client system memory according to some embodiments;

FIG. 6 is a block diagram of a distributed ledger system according to some embodiments;

FIG. 7 is a block diagram of a distributed ledger system memory 144 according to some embodiments;

FIG. 8 is a process flow diagram of a method of issuing a contract token according to some embodiments;

FIG. 9 is a process flow diagram of a method of issuing a contract token and facilitating a transaction according to some embodiments;

FIG. 10 is a process flow diagram of a method of transacting using a contract token;

FIG. 11 illustrates a client system according to some embodiments;

FIG. 12 illustrates a merchant system according to some embodiments;

FIG. 13 is a block diagram illustrating an example computing device, in accordance with an embodiment.

### DESCRIPTION OF EMBODIMENTS

Described embodiments relate to systems, computer-implemented method and computer programs for managing a contract token associated with a distributed ledger.

### Overview of System

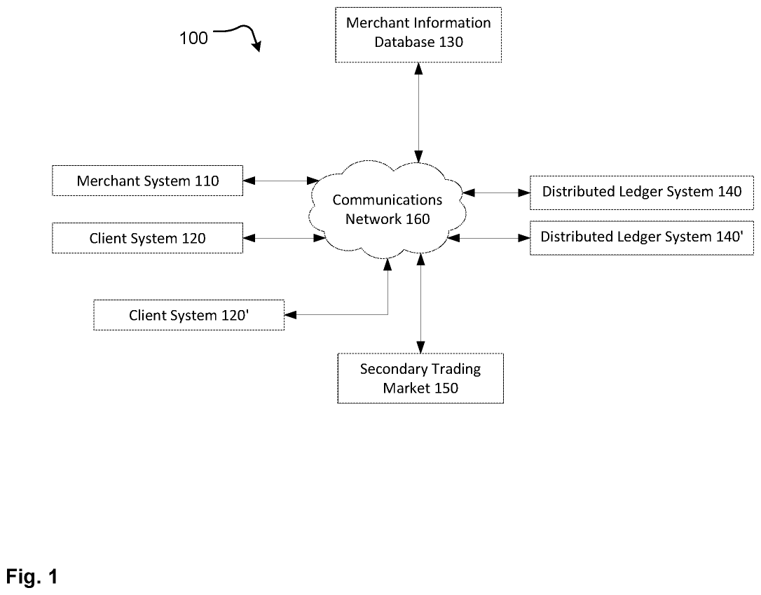

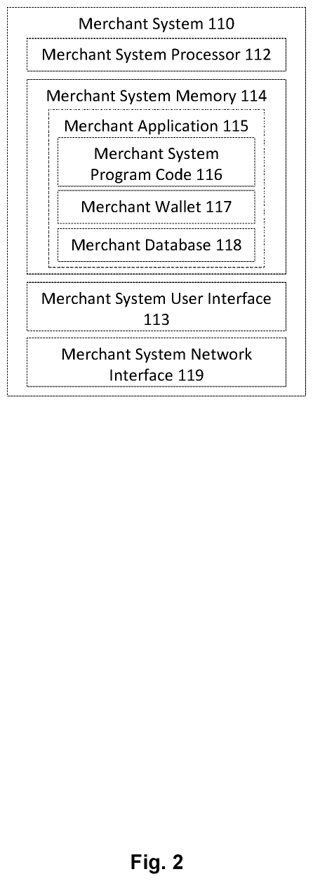

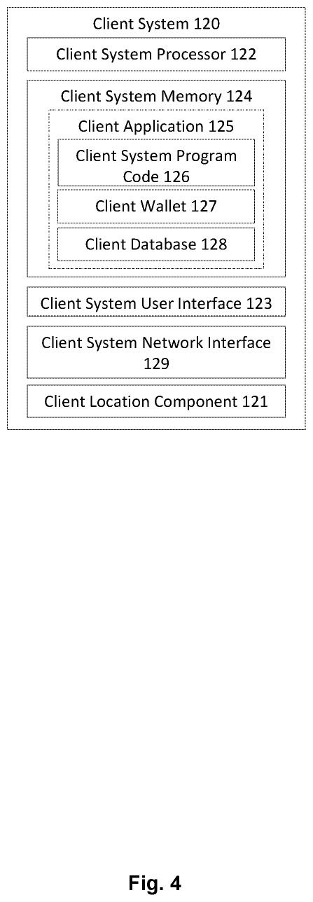

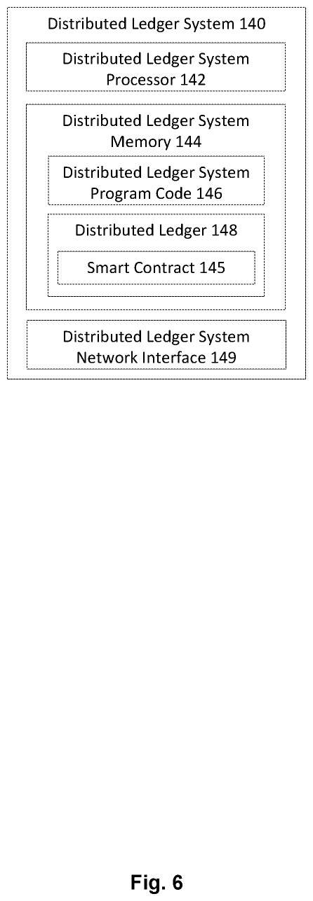

FIG. 1 illustrates an exemplary system 100 according to some embodiments. The system 100 comprises a merchant system 110 and a client system 120. In this example, the merchant system 110 and the client system 120 are in communication, via a communications network, to a distributed ledger system 140. The merchant system 110 is shown in detail in FIG. 2. The merchant system 110 is associated with a merchant and, in some examples, the merchant is associated with a merchant information database 130 to store merchant information. The client system 120 is shown in detail in FIG. 4. The client system 120 is associated with a client. The distributed ledger system 140 is shown in detail in FIG. 6. In some embodiments, the system 100 includes a second merchant system 110′, a second client system 120′ and/or a second distributed ledger system 140′.

### Merchant System

The merchant system 110 comprises at least one merchant system processor 112 and merchant system memory 114. The merchant system 110 comprises a merchant system user interface 113. The merchant system 110 is configured to communicate with one or more network enabled computing devices over the communications network 160. A merchant system network interface 119 allows the merchant system 110 to communicate over the communications network 160. The merchant system network interface 119 may comprise a combination of network interface hardware and network interface software suitable for establishing, maintaining and facilitating communication over a relevant communication channel. Examples of a suitable communications network 160 include a cloud server network, wired or wireless internet connection, Bluetooth™ or other near field radio communication, and/or physical media such as USB.

The at least one merchant system processor 112 is configured to execute merchant system program code 116 stored in merchant system memory 114 to cause the merchant system 110 to function according to the described methods. The at least one merchant systems processor 112 may comprise one or more microprocessors, central processing units (CPUs), application specific instruction set processors (ASIPs), application specific integrated circuits (ASICs) or other processors capable of reading and executing instruction code.

Merchant system memory 114 may comprise one or more volatile or non-volatile memory types. For example, merchant system memory 114 may comprise one or more of random access memory (RAM), read-only memory (ROM), electrically erasable programmable read-only memory (EEPROM) or flash memory. Merchant system memory 114 is configured to store merchant system program code 116 accessible by the at least one merchant system processor 112. The merchant system program code 116 comprises executable program code modules. In other words, merchant system memory 114 is configured to store executable code modules configured to be executable by the at least one merchant system processor 112. The executable code modules, when executed by the at least one merchant system processor 112 cause the merchant system 110 to perform certain functionality.

The merchant system user interface 113 is configured to receive a merchant system input. The merchant system input may be an input provided by the merchant. The merchant system user interface 113 is configured to provide a merchant system output. In some embodiments, the merchant system output comprises a visual output. In some embodiments, the merchant system output is provided via a merchant system display unit. The merchant system display unit may be implemented as a liquid crystal display, a plasma screen, as a cathode ray screen device or the like. According to some embodiments, merchant system display unit may comprise a touch screen display. In some embodiments, the merchant system output comprises an audible merchant system output.

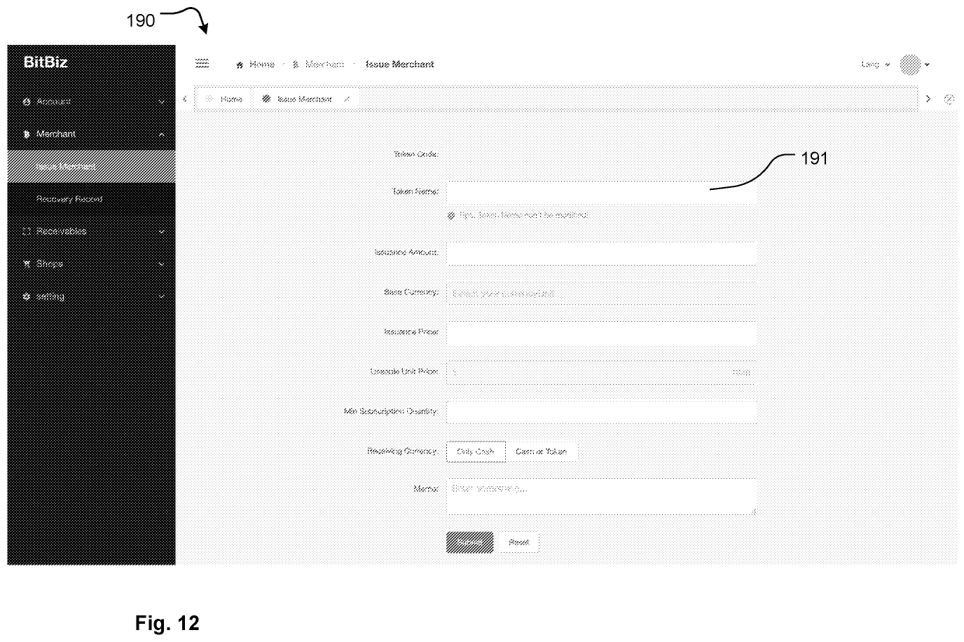

In some embodiments, the merchant system memory 114 stores a merchant application 115. The merchant application 115 may comprise the merchant system program code 116, a merchant wallet 117 and/or a merchant database 118. Upon execution by the at least one merchant system processor 112, the merchant application 115 may generate a merchant application interface 190. An exemplary merchant application interface is shown in FIG. 12. The merchant application interface 190 may be displayed using the merchant system user interface 113. The merchant may provide inputs indicative of one or more parameters using the merchant application interface 190.

The merchant system comprises the merchant wallet 117. In some embodiments, the merchant system memory 114 stores the merchant wallet 117. The merchant wallet 117 is a digital asset wallet associated with a distributed ledger. The distributed ledger, and the distributed ledger system 140 are described in more detail below.

The merchant wallet 117 may store a merchant private key associated with a distributed ledger. The merchant private key may be a cryptographic private key. The merchant private key provides the merchant with control over one or more merchant wallet addresses. The merchant wallet 117 may derive one or more merchant public keys from the merchant private key. The merchant wallet 117 may derive the one or more merchant wallet addresses from the merchant public key. Therefore, the merchant wallet 117 may derive the merchant wallet addresses from the merchant wallet private key.

The merchant private key provides the merchant with control of one or more digital assets associated with the merchant private key. In some embodiments, the merchant private key provides the merchant with control of one or more digital assets associated with the one or more merchant wallet addresses. The merchant private key allows the merchant to transfer ownership of the digital asset(s) associated the merchant private key and/or each of the one or more merchant wallet addresses to another distributed ledger private key and/or another distributed ledger wallet address. The merchant wallet 117 may use the merchant private key to generate a merchant digital signature. The merchant digital signature may be used to initialize a transaction on the distributed ledger 148 involving the digital asset(s) associated with the merchant private key as a proof that the merchant is the owner of the digital asset(s) and/or the merchant wallet address, and to verify validity of the transaction.

For the purposes of some embodiments, a transfer of ownership of a digital asset may comprise transferring control of the digital asset from a first entity to a second entity. Thus, the digital asset may be considered to be owned by the entity that controls the wallet with which the digital asset is associated with. Transferring ownership of the digital asset may comprise transferring control of the digital asset from a first entity wallet (controlled by a first entity private key in the custody of the first entity) to a second entity wallet (controlled by a second entity private key in the custody of the second entity). Before the transfer of ownership, the second entity may have no, or reduced control over the digital asset. Before the transfer of ownership, the first entity may have complete, or partial control over the digital asset. After the transfer of ownership, the first entity may no longer have complete or partial control over the digital asset. After transfer of ownership, the second entity may have complete or partial control over the digital asset. That is, the second entity may be able to, itself, then transfer ownership of the digital asset. The digital asset may be in the form of the digital asset associated with the distributed ledger 148, and/or in the form of the contract token.

The merchant wallet 117 may store cryptographic private keys for a plurality of distributed ledgers. The private keys for the plurality of distributed ledgers may have different formats such as a different length of bits, and may be in compliance with different cryptographic protocols.

The merchant system 110 comprises a merchant database 118. In particular, the merchant system memory 114 may store the merchant database 118. The merchant database 118 may store merchant information. The merchant information may be publicized and be publically available. The merchant information includes information characterising the merchant. For example, the merchant information can include the merchant name, the address of one or more merchant premises, merchant contact information (phone number, email address, website), merchant product information and product pricing etc. The merchant database 118 may be accessible over the communications network 160. In some embodiments, the merchant database 118 may also include a copy of the distributed ledger 148.

In some embodiments, the system 100 may comprise another merchant system 110′. In some embodiments, this is a second merchant system 110′. The merchant system 110′ may be in communication with one or more of the merchant system 110, the client system 120, the client system 120′, the secondary trading market 150, the merchant information database 130, the distributed ledger system 140 and/or the distributed ledger system 140′. It is to be appreciated that there can be a plurality of other merchants and respective merchant systems.

In some embodiments, the merchant system 110 comprises a first merchant system computing device and a second merchant system computing device. The first merchant system computing device may be configured to perform a portion of the functionality of the merchant system 110 as herein described. The second merchant system computing device may be configured to perform a second portion of the functionality of the merchant system 120 as herein described. The first merchant system computing device and the second merchant system computing device may be in communication via the communications network 160. In some embodiments, the first merchant system computing device is configured to receive one or more merchant inputs and to communicate those with the second merchant system computing device. In some embodiments, the second merchant system computing device is configured to process the one or more merchant inputs and perform a portion of the functionality of the merchant system 110 as herein described. In some embodiments, the second merchant system computing device may be a third party computing device. That is, the functionality of the second merchant system computing device may be performed by a third party that is not the merchant.

### Client System

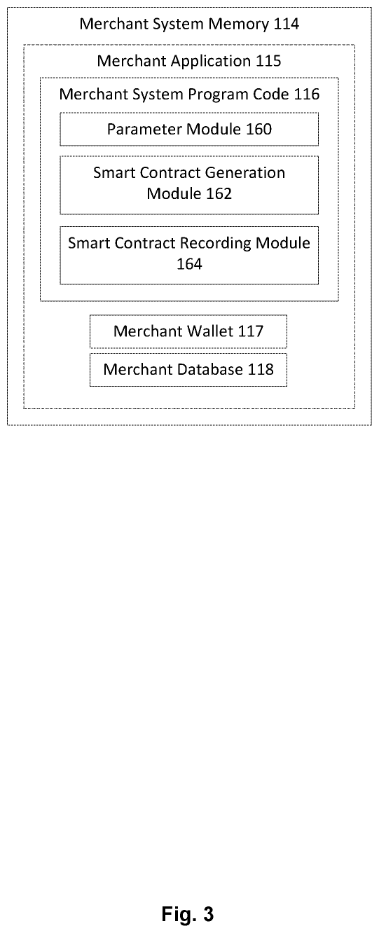

Referring to FIG. 3, the system 100 comprises the client system 120. The client system 120 comprises at least one client system processor 122 and client system memory 124. The client system 120 comprises a client system user interface 123. The client system 120 is configured to communicate with one or more network enabled computing devices over the communications network 160. In particular, the client system 120 is configured to communicate with the merchant system 100 over the communications network 160. A client system network interface 129 allows the client system 120 to communicate over the communications network 160. The client system network interface 129 may comprise a combination of network interface hardware and network interface software suitable for establishing, maintaining and facilitating communication over a relevant communication channel.

The at least one client system processor 122 is configured to execute client system program code 126 stored in client system memory 124 to cause the client system 120 to function according to the described methods. The at least one client system processor 122 may comprise one or more microprocessors, central processing units (CPUs), application specific instruction set processors (ASIPs), application specific integrated circuits (ASICs) or other processors capable of reading and executing instruction code.

Client system memory 124 may comprise one or more volatile or non-volatile memory types. For example, client system memory 124 may comprise one or more of random access memory (RAM), read-only memory (ROM), electrically erasable programmable read-only memory (EEPROM) or flash memory. Client system memory 124 is configured to store client system program code 126 accessible by the at least one client system processor 122. The client system program code 126 comprises executable program code modules. In other words, client system memory 124 is configured to store executable code modules configured to be executable by the at least one client system processor 122. The executable code modules, when executed by the at least one client system processor 122 cause the client system 120 to perform certain functionality.

The client system user interface 123 is configured to receive a client system input. The client system input may be an input provided by the client. The client system user interface 123 is configured to provide a client system output. In some embodiments, the client system output comprises a visual client system output. In some embodiments, the client system output may be provided via a client system display unit. The client system display unit may be implemented as a liquid crystal display, a plasma screen, as a cathode ray screen device or the like. According to some embodiments, client system display unit may comprise a touch screen display. In some embodiments, the client system output comprises an audible client system output.

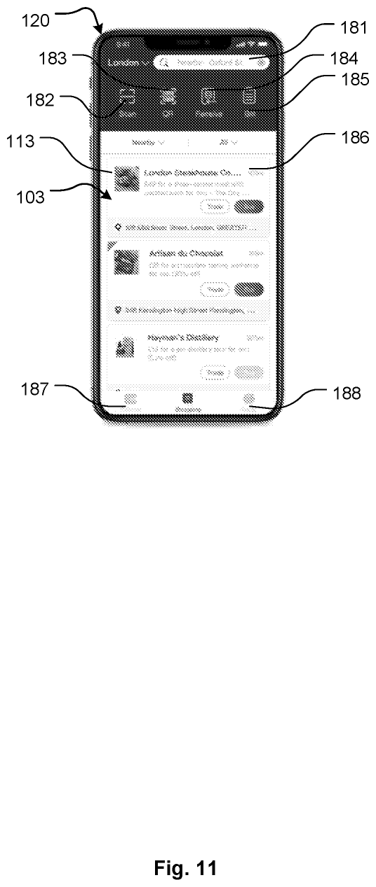

In some embodiments, the client system memory 124 stores a client application 125. The client application 125 may comprise the client system program code 126, a client wallet 127 and/or a client database 128. Upon execution by the at least one client system processor 122, the client application 125 may generate a client application interface 103. An exemplary client application interface 103 is shown in FIG. 11. The client application interface 103 may be displayed using the client system user interface 123.

In some embodiments, the client system memory 124 stores the client wallet 127. The client wallet 127 is a digital asset wallet. The client wallet 127 may store a client private key. The client private key may be a cryptographic private key. The client private key provides the client with control over one or more client wallet addresses. The client wallet 127 may derive one or more client public keys from the client private key. The client wallet 127 may derive the one or more client wallet addresses from the client public key. Therefore, the client wallet 127 may derive the client wallet addresses from the client wallet private key.

The client private key provides the client with control of one or more digital assets associated with the client private key. In some embodiments, the client private key provides the client with control of one or more digital assets associated with the one or more client wallet addresses. The client private key allows the client to transfer ownership of the digital asset(s) associated the client private key and/or each of the one or more client wallet addresses to another distributed ledger private key and/or another distributed ledger wallet address. The client wallet 127 may use the client private key to generate a client digital signature. The client digital signature may be used to initialize a transaction on the distributed ledger 148 involving the digital asset(s) associated with the client private key as a proof that the client is the owner of the digital asset(s) and/or the client wallet address, and to verify validity of the transaction.

The client wallet 127 may store cryptographic private keys for a plurality of distributed ledgers. The private keys for the plurality of distributed ledgers may have different formats such as a different length of bits, and may be in compliance with different cryptographic protocols.

The client system 120 may comprise a client database 128. In particular, the client system memory 124 may store the client database 128. The client database 128 may include client information. The client information includes information characterising the client. For example, the client information can include the client name, client address or client contact information (phone number, email address, website). In some embodiments, the client database 128 may also include a copy of the distributed ledger.

The client system 120 is configured to determine a client system geographic location. That is, the client system 120 is configured to determine an estimate of its geographic location. The client system 120 comprises a client location component 121. The client location component 121 is configured to generate a location signal indicative of the client system geographic location. In some embodiments, the client location component 121 is configured to provide the location signal to the at least one client system processor 122. The at least one client system processor 122 is then configured to determine the client system geographic location (the determination need not be exact, an estimate, for example within a 1, 10 or 100 metre radius may be sufficient). In some embodiments, the client location component 121 is in the form of an antenna and accompanying hardware and software. The client system 120 may be configured to determine the client system geographic location using one of a number of methods. For example, the client system 120 may use Global Positioning System (GPS) triangulation (or other satellite based navigation and positioning system), cell tower triangulation, WiFi and/or Bluetooth positioning methods or other location methods. In some example, an geographic location may be larger than 100 metres. For example, the system may work on a suburb, town, city or county level. Therefore the general location may be determined by other means, including analysis of an IP address of the device, or determining which cell tower is in range of the device.

In some embodiments, the system 100 may comprise another client system 120′. In some embodiments, this is a second client system 120′. The client system 120′ may be in communication with one or more of the client system 120, the merchant system 110, the merchant system 110′, the secondary trading market 150, the merchant information database 130, the distributed ledger system 140 and/or the distributed ledger system 140′.

In some embodiments, the client system 120 comprises a first client system computing device and a second client system computing device. The first client system computing device may be configured to perform a portion of the functionality of the client system 120 as herein described. The second client system computing device may be configured to perform a second portion of the functionality of the client system 120 as herein described. The first client system computing device and the second client system computing device may be in communication via the communications network 160. In some embodiments, the first client system computing device is configured to receive one or more client inputs and to communicate those with the second client system computing device. In some embodiments, the second client system computing device is configured to process the one or more client inputs and perform a portion of the functionality of the client system 120 herein described. In some embodiments, the second client system computing device may be a third party computing device (such as provided by a third party provider hosting a service). That is, the functionality of the second client system computing device may be performed by a third party that is not the client.

### Distributed Ledger System

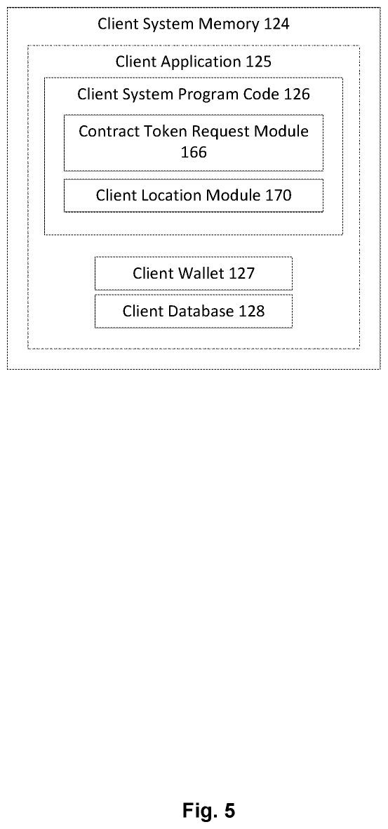

Referring to FIG. 5, the system 100 comprise at least one distributed ledger system 140. The distributed ledger system 140 is associated with the distributed ledger 148. The distributed ledger 148 is a ledger database that exists on a plurality of distributed ledger systems 140 connected over the communications network 160. At least one distributed ledger system 140 may store a complete copy of the distributed ledger 148. Alternatively, at least one distributed ledger system 140 may store a portion of the distributed ledger 148, where multiple portions make up the distributed ledger. The respective distributed ledger systems 140 share and synchronise their respective copies (or portions) of the distributed ledger 148 with one or more other distributed ledger systems 140 over the communications network 160. The distributed ledger systems 140 may implement an agreed upon consensus mechanism to achieve agreement of a state of the distributed ledger 148 at a particular point in time. In at least one form, each distributed ledger system 140 can be considered a distributed ledger node.

A blockchain is a specific implementation of distributed ledger technology. A blockchain is a distributed ledger comprising two or more blocks that are linked together and that adhere to a predetermined standard or protocol. Each block can be considered a container data structure comprising block data. The block data may comprise a cryptographic hash of a previous block, a timestamp and/or ledger data. The ledger data can include one or more transaction records. Each transaction record may represent a transfer of ownership of a digital asset from one entity to another. In particular, each transaction record may represent a transfer of ownership of a digital asset from one entity in control of a first cryptographic private key to another entity in control of a second cryptographic private key. In some embodiments, the distributed ledger 148 is in the form of a blockchain.

The smart contract 145 is a computer program intended to digitally facilitate, verify and/or enforce the negotiation or performance of a contract. The smart contract 145 can allow for the execution of one or more terms of a contract without a third party intermediary enforcing the terms. The smart contract 145 can be recorded as a transaction in the distributed ledger 148. For example, where the distributed ledger 148 is in the form of a blockchain, the smart contract 145 can be recorded as a transaction in the blockchain. The smart contract 145 can therefore be associated with a smart contract address (and/or a private key) of the distributed ledger 148. When deployed, a constructor of the smart contract 145 can execute and initialise the state of the smart contract 145. The state of the smart contract 145 can be persistently stored in the distributed ledger 148. This may be achieved, for example, by way of a Merkel tree. When a transaction is recorded against the smart contract 145, a message may be sent to the smart contract 145, and the program code of the smart contract 145 may execute to implement the terms of the contract. As the distributed ledger 148′, and thus the smart contract 145 is stored on each distributed ledger system 140, in some embodiments, the program code of the smart contract is executed by each distributed ledger system 140, 140′. Thus, the terms of the smart contract are enforced reliably across all distributed ledger systems 140, 140′ (a distributed network) associated with the distributed ledger. In some embodiments, the distributed ledger system 140 executes the program code of the smart contract 145, and communicates the result of the execution of the smart contract 145 to other distributed ledger systems 140, 140′. This result may be communicated via the communications network 160.

A contract token is associated with the smart contract 145. The smart contract 145 is programmed to dictate the issuance and subsequent use of the contract token in accordance with one or more parameters of the smart contract 145 as will be described in more detail. The contract token may comprise at least three attributes. The contract token may comprise a monetary attribute. That is, the contract token can have a monetary value. The contract token may be issued in such a way that it is divisible, fungible and easily transferrable, such as cash. The contract token may be valued in such a way that transfer of ownership of the contract token can be equivalent to a value transfer. The contract token may comprise an interest attribute. The contract token may therefore be representative of an ownership or interest in one or more entities. For example, the interest attribute of the contract token can be analogous to ownership of a stock of a business. The contract token may comprise a functional attribute. In such a case, the contract token may provide a functional benefit to the owner. For example, the contract token may act as a ticket granting the owner access to goods and/or services offered by the merchant. In such a case, the contract token may provide a functional attribute including, but not limited to exclusive privileges, memberships, discounts and pre-emptive rights etc.

The distributed ledger system 140 comprises at least one distributed ledger system processor 142 and distributed ledger system memory 144. The distributed ledger system 140 is configured to communicate with one or more network enabled computing devices over the communications network 140. In particular, the distributed ledger system 140 is configured to communicate with the merchant system 110 and/or the client system 120 over the communications network 160. A distributed ledger system network interface 149 allows the distributed ledger system 140 to communicate over the communications network 160. The distributed ledger system network interface 149 may comprise a combination of network interface hardware and network interface software suitable for establishing, maintaining and facilitating communication over a relevant communication channel.

The at least one distributed ledger system processor 142 is configured to execute distributed ledger system program code 146 stored in distributed ledger system memory 144 to cause the distributed ledger system 140 to function according to the described methods. The at least one distributed ledger system processor 142 may comprise one or more microprocessors, central processing units (CPUs), application specific instruction set processors (ASIPs), application specific integrated circuits (ASICs) or other processors capable of reading and executing instruction code.

Distributed ledger system memory 144 may comprise one or more volatile or non-volatile memory types. For example, distributed ledger system memory 144 may comprise one or more of random access memory (RAM), read-only memory (ROM), electrically erasable programmable read-only memory (EEPROM) or flash memory. Distributed ledger system memory 144 is configured to store distributed ledger system program code 146 accessible by the at least one distributed ledger system processor 142. The distributed ledger system program code 146 comprises executable program code modules. In other words, distributed ledger system memory 144 is configured to store executable code modules configured to be executable by the at least one distributed ledger system processor 142. The executable code modules, when executed by the at least one distributed ledger system processor 142 cause the distributed ledger system 140 to perform certain functionality.

In some embodiments, the distributed ledger 148 is a public distributed ledger. That is, the distributed ledger 148 can have no access restrictions. That is, any computing device that can connect to the communications network 160 can become a distributed ledger system 140, and send transactions on the distributed ledger 148. In other words, the distributed ledger 148 may be a permissionless distributed ledger.

In some embodiments, the distributed ledger 148 is a private distributed ledger. That is, access to the distributed ledger 148, and the ability to send transactions on the distributed ledger 148 can be restricted by one or more mechanisms. In other words, the distributed ledger may be a permissioned distributed ledger.

In some embodiments, the system 100 may comprise another merchant system 110′. In some embodiments, this is a second merchant system. The merchant system 110′ may be in communication with one or more of the merchant system 110, the client system 120, the secondary trading market 150, the merchant information database 130, the distributed ledger system 140 and/or the distributed ledger system 140′. It is to be appreciated that there can be a plurality of other merchants and respective merchant systems.

### Merchant Information Database

In some embodiments, the system 100 comprises the merchant information database 130. The merchant information database 130 may store merchant information. The merchant information can include information characterising a plurality of merchants associated with the system 100. The merchant information can include the merchant name, the physical address of one or more merchant premises, merchant contact information (phone number, email address, website), merchant product information and product pricing etc. The merchant information database 130 may be accessible over the communications network 160. In some embodiments, the merchant information database 130 may include a copy of the distributed ledger 148. The merchant information database 130 may be maintained by the merchant. Alternatively, the merchant information database 130 may be maintained by a third party. The third party may issue the merchant application 115 to a plurality of merchants, and the client application 125 to a plurality of clients.

In some embodiments, the merchant information database 130 may store the merchant application 115. In such embodiments, the merchant application 115 may not be stored on the merchant system 110. This can advantageously reduce the memory requirements of the merchant system 110. The merchant system 110 may access the merchant application 115 via a rendering of the merchant application interface 190. In these embodiments, the merchant information database 130 may generate merchant application interface program code. The merchant application interface program code may be communicated to the merchant system 110 via the communications network 160. The merchant application interface program code may be rendered by the merchant system 110 for display. In particular, the merchant application interface program code may be rendered by the merchant system 110 for display on the merchant system user interface 113. In these embodiments, the merchant application interface 190 may be in the form of a webpage or online portal.

In some embodiments, the merchant information database 130 may store the client application 125. In such embodiments, the client application 125 may not be stored on the client system 120. This can advantageously reduce the memory requirements of the client system 120. The client system 120 may access the client application 125 via the a rendering of the client application interface 103. In these embodiments, the merchant information database 130 may generate client application interface program code. The client application interface program code may be communicated to the client system 120 via the communications network 160. The client application interface program code may be rendered by the client system 120 for display. In particular, the client application interface program code may be rendered by the client system 120 for display on the client system user interface 123. In these embodiments, the client application may be accessed via an network browser (such as in the form of a webpage or online portal).

### Secondary Trading Market

In some embodiments, the system 100 comprises a secondary trading market 150. The secondary trading market 150 may be in the form of a secondary trading market server. The secondary trading market 150 facilitates trading of one or more digital assets between two or more parties. For example, the secondary trading market 150 may facilitate trading of one or more digital assets between client systems 120 and 120′. In some examples, trading may occur at, or close to the post-issuance ratio (e.g. it may be artificially pegged to the post-issuance ratio). In other examples, trading may be a free market.

### Merchant System Software

Referring to FIG. 3, merchant system memory 114 may comprise a parameter module 160. In some embodiments, the merchant system program code 116 comprises the parameter module 160. The parameter module 160 is configured to receive one or more parameters. The parameter module 160 is also configured to store the one or more parameters. The one or more parameters may be stored on the merchant system memory 114. The one or more parameters can be one or more parameters of a contract. In some embodiments, the one or more parameters may represent the contract. In some embodiments, the one or more parameters may define conditions of the contract. The one or more parameters may be received via the merchant application. In particular, the one or more parameters may be received via the client application user interface 103.

Merchant system memory 114 may comprise a smart contract generation module 162. In some embodiments, the merchant system program code 116 comprises the smart contract generation module 162. The smart contract generation module 162 is configured to generate the smart contract 145. In particular, the smart contract generation module 162 is configured to generate the smart contract 145 such that the smart contract 145 represents the contract in accordance with the one or more parameters. The smart contract generation module 162 is configured to generate the smart contract 145 using the one or more parameters received and stored by the parameter module 160.

The one or more parameters may relate to, but are not limited to a number of the contract tokens to be issued, an issuance time of the contract token, an issuance price of the contract token, a minimum subscription quantity of the contract token at issue and/or a useable unit price of the contract token. The smart contract 145 may define the conditions of ownership of the contract token, a mechanism of transferring ownership of the contract token, and any conditions associated with the transfer of ownership of the contract token.

The contract token may be associated with one or more location-based condition(s). For example, the contract token may be associated with one or more particular merchant locations of a merchant. That is, the contract tokens may be restricted to be exchangeable only at one or more specified merchant locations. For example, each merchant location may have a respective merchant wallet address that is different from each other merchant location. The smart contract 145 may be generated to restrict transfer of ownership of the contract token, except to one of the merchant wallet addresses of merchant locations according to the one or more location-based condition(s). In some embodiments, at least part of the location-based condition(s) is published on the distributed ledger.

The issuance time represent a time that the contract token is to be issued. For example, the issuance time may be a specified time and date. Alternatively, the issuance time may be specified with respect to the state of the distributed ledger. For example, where the distributed ledger is a blockchain, the issuance time may be expressed as a block number of a block that is expected to be added to the blockchain in the future. The minimum subscription quantity is the minimum number of contract tokens that may be requested, and subsequently issued. The useable unit price may specify a price at which the contract token can be exchanged with a particular counterparty (for example, the merchant) after issue of the contract token.

Merchant system memory 114 may comprise a smart contract recording module 164. In some embodiments, the merchant system program code 116 comprises the smart contract recording module 164. The smart contract module 164 is configured to record the smart contract 145 on the distributed ledger 148. In particular, the smart contract may be recorded as a transaction on the distributed ledger 148.

### Distributed Ledger System Software

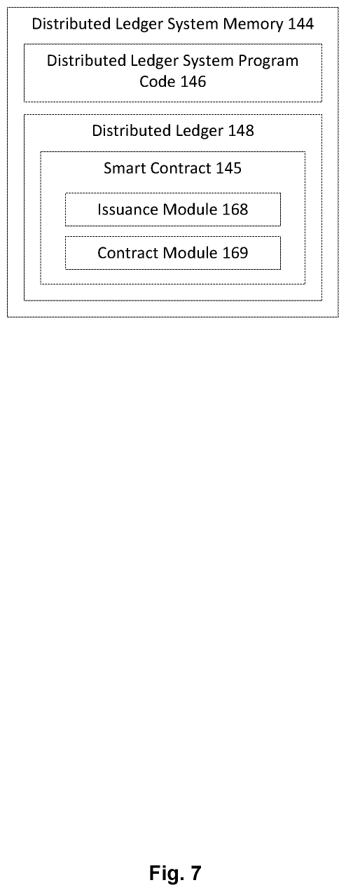

Referring to FIG. 7, distributed ledger system memory 144 may comprise an issuance module 168. In some embodiments, the smart contract 145 comprises the issuance module 168. The issuance module 168 is configured to receive a request for the contract token. In some embodiments, receiving the request for the contract token comprises detection of a transfer of ownership of a unit of account. The unit of account can be, for example, be the digital asset associated with the distributed ledger 148. In some embodiments, the unit of account is a cryptocurrency, a fiat currency, a real asset or a financial asset. The unit of account may have a base unit. The base unit may be a reference unit of the unit of account. For example, the base unit of the United States dollar may be one cent. Alternatively the base unit of the United States dollar may be one dollar. The issuance module 168 is further configured to issue the contract token in accordance with the smart contract 145. In some embodiments, issuing the contract token comprises transferring ownership of the contract token.

Distributed ledger system memory 144 may comprise a contract module 169. In some embodiments, the smart contract 145 comprises the contract module 169. The contract module 169 is configured to enforce the terms of the smart contract 145. That is, the contract module 169 enforces the parameters of the contract. In some embodiments, the contract module 169 enforces the parameters of the contract to establish ownership of the contract token, the mechanism of transferring ownership of the contract token, and any conditions associated with the transfer of ownership of the contract token.

### Client System Software

Referring to FIG. 5, client system memory 124 may comprise a contract token request module 166. In some embodiments, the client system program code 126 comprises the contract token request module 166. The contract token request module 166 is configured to generate a request for the contract token. The contract token request module 166 is configured to send the request for the contract token. The contract token request module 166 may be configured to send the request for the contract token to the smart contract 148 and/or to the merchant. In particular, the contract token request module 166 may be configured to send the request for the contract token to the smart contract address, and/or to the merchant wallet address.

Client system memory 124 may comprise a client location module 170. The client location module 170 is configured to determine the client system geographic location. The client location module 170 may be configured to determine the client system geographic location as previously described. For example, the client location module 170 may determine the client system geographic location using GPS triangulation, cell tower triangulation or another method (as described above). In particular, the client location module 170 is configured to determine the client system geographic location using the location signal generated by the client location component 121.

### Computer-Implemented Method of Issuing the Contract Token

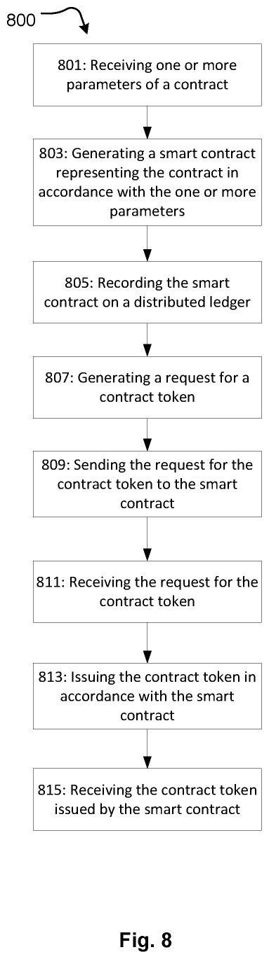

Referring now to FIG. 8, there is shown a process flow diagram of a computer-implemented method 800 according to some embodiments. In some embodiments, the method 800 is performed by the system 100 illustrated in FIG. 1, or one or more components or sub-systems of the system 100.

At 801, one or more parameters of a contract are received. The one or more parameters of the contract are received by the merchant system 110. The one or more parameters may also be stored. For example, the one or more parameters may be stored by the merchant system memory 114. The one or more parameters of the contract are received via the merchant application interface 190. In some embodiments, the one or more parameters are received and stored by the parameter module 160. In particular, the one or more parameters are received by way of one or more inputs provided via the merchant system user interface 113. That is, the merchant provides the one or more parameters via the merchant system user interface 113. The one or more parameters detail the terms of the contract. For example, as previously described, the one or more parameters may relate to, but are not limited to a number of the contract tokens to be issued, an issuance time of the contract token, an issuance price of the contract token, a minimum subscription quantity of the contract token at issue and/or a useable unit price of the contract token.

At 803, the smart contract 145 is generated. The smart contract 145 is generated to represent the contract in accordance with the one or more parameters. The smart contract 145 is generated by the merchant system 110. In particular, the smart contract is generated by the smart contract generation module 160.

At 805, the smart contract 145 is recorded on the distributed ledger 148. The smart contract 145 may be recorded on the distributed ledger 148 by the merchant system 110. In particular, the smart contract 145 may be recorded on the distributed ledger by the smart contract recording module 164. Recording the smart contract 145 on the distributed ledger 148 may comprise generating a record transaction that associates the smart contract 145 with the smart contract address of the distributed ledger 148. The record transaction can be communicated to the distributed ledger system 140, and recorded on the distributed ledger 148 in accordance with the distributed ledger's 148 consensus mechanism.

At 807, a request for the contract token is generated. In some embodiments, the request for the contract token is generated by the contract token request module 166. Thus, the request for the contract token is generated by the client system 120. Generating the request for the contract token may comprise generating a request transaction for inclusion in the distributed ledger 148. The request transaction may involve the transfer of ownership of a unit of account. The unit of account can be, for example, be the digital asset associated with the distributed ledger 148. In some embodiments, the unit of account is a cryptocurrency, a fiat currency, a real asset or a financial asset.

The fiat currency may, for example, comprise a government-issued currency such as the United States Dollar, the Renminbi or another government-issued currency. The cryptocurrency may, for example, comprise Bitcoin, Ethereum, USD Tether, or another cryptocurrency. The real asset may, for example, comprise real estate, equipment, natural resources or precious metals. The financial asset may, for example, comprise a bank deposit, a bond or a stock.

The request for the contract token may comprise the transfer of ownership of the unit of account to the smart contract 145 and/or the merchant. The unit of account may then be re-directed in accordance with the smart contract 145. For example, ownership of the unit of account may be transferred to the merchant. Alternatively, the request for the contract token may comprise the transfer of ownership of the unit of account directly to the merchant, for example, by transferring ownership to the merchant wallet address. Where the unit of account is the digital asset associated with the distributed ledger 148, generating the request for the contract token may comprise generating the request transaction transferring ownership of the digital asset to the smart contract 142 and/or the merchant.

At 809, the request for the contract token is sent. The request for the contract token is sent in accordance with the requirements of the smart contract 145. In some embodiments, sending the request for the contract token comprises sending the request transaction from the merchant system 110 to the distributed ledger system 140. Sending the request for the contract token may also be executed by the contract token request module 166.

At 811, the request for the contract token is received. The request for the contract token is received in accordance with the smart contract 145. For example, the request transaction is confirmed to have been executed by being included in the distributed ledger 148. Receiving the request for the contract token may be executed by the issuance module 168.

At 813, the contract token is issued in accordance with the smart contract. The contract token may be issued by execution of the contract module 169. Ownership of the contract token is transferred to the client system 120. The contract token may therefore be associated with the client system wallet address.

As described, in some embodiments, the contract token is issued in exchange for the transfer of ownership of the unit of account. In particular, the contract token is issued in exchange for the transfer of ownership to the merchant of the unit of account at an issuance ratio. The issuance ratio represents the quantity of contract tokens issued in exchange for a base unit of the unit of account. In other words, the issuance ratio corresponds to a ratio between an issuance quantity of the contract token (i.e. the number of contract tokens issued) per base unit of the unit of account. In other words, receiving the request for the contract token comprises the transfer of ownership of a number of base units of the unit of account to the merchant at the issuance ratio. In some embodiments, the contract token is issued in exchange for the transfer of ownership of the number of base units of the unit of account to the smart contract address. The smart contract 145 is programmed to make the unit of account available to the merchant. This may involve transferring ownership of the unit of account to the merchant.

In some examples, the contract tokens are associated with other assets of a merchant. This may include mortgaging other assets when issuing the contract tokens, where the other assets have a value representing at least part (as a margin) of the value of the issued contract tokens. In some examples, the other assets may be a digital asset whereby the mortgage conditions on the other assets are controlled through the smart contract 145.

The first time can be indexed to the issuance time. That is, the first time can be related to and/or proportional to the issuance time. In some embodiments, the first time is the time at which the transfer of ownership of the unit of account to the merchant or to the smart contract address is executed.

The contract token is exchangeable, after issuance, with the merchant at a post-issuance ratio. The post-issuance ratio corresponds to an exchangeable quantity of the contract token, the exchangeable quantity being exchangeable with the merchant for goods and/or services valued at the base unit of the unit of account. The exchangeable quantity of the contract token is exchangeable with the merchant, after issue, for the goods or services offered by the merchant at a second time. The second time is after the first time.

In some embodiments, the merchant issuing the contract token can provide a financial incentive to clients that request the contract token prior to issuance. The merchant can achieve this by offering goods and/or services in exchange for the contract token a discounted price relative to the price offered for the goods or services in the unit of account. That is, the issuance ratio of the contract token can be greater than the post-issuance ratio of the contract token. For example, the smart contract 145 may issue 2 contract tokens for every base unit of the unit of account, and the merchant may provide 2 base units worth of goods and/or services for each of those contract tokens after issue. In other words, the post-issuance ratio can be less than the issuance ratio. That is, the purchasing power (from the point of view of the unit of account) at the issuance ratio is better than at the post-issuance ratio. In some embodiments, the issuance ratio can be equal to the post-issuance ratio. That is, the number of base units of the unit of account exchanged for the contract token at issuance is equal to the number of base units worth of goods and/or services provided by the merchant in exchange for the contract token after issuance. In some embodiments, the issuance ratio can be less than the post-issuance ratio. In other words, in some embodiments, the post-issuance ratio can be greater than the issuance ratio.

The contract token may be associated with one or more location-based condition(s). In some embodiments, the merchant may accept exchange of the contract token for goods and/or services at the post-issuance ratio at one or more specified merchant locations. For example, where the merchant has a plurality of merchant locations offering goods and/or services, the merchant may accept exchange of the contract token for goods and/or services at a specified subset of these merchant locations.

At 815, the contract token issued by the smart contract is received. Receiving the contract token may comprise a transfer of ownership of the contract token from the smart contract 145 to the client system 140. The contract token may be received at the client wallet address. In other words, the contract token may be associated with the client wallet address. This association may be verified on the distributed ledger.

### Computer-Implemented Method of Exchanging the Contract Token

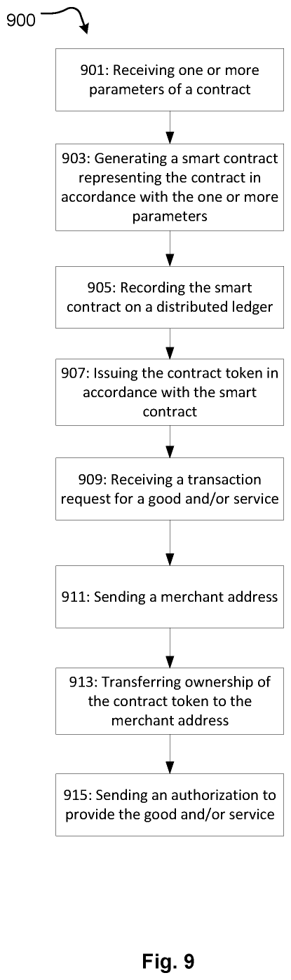

Referring now to FIG. 9, there is shown a process flow diagram of a computer-implemented method 900 according to some embodiments. In some embodiments, the method 900 is performed by the system 100 illustrated in FIG. 1, or one or more components or sub-systems of the system 100.

At 901, one or more parameters of a contract are received. The one or more parameters of the contract are received by the merchant system 110. In particular, the one or more parameters are received by way of one or more inputs provided via the merchant system user interface 113.

At 903, the smart contract 145 is generated. The smart contract 145 is generated to represent the contract in accordance with the one or more parameters. The smart contract 145 is generated as described with reference to 803.

At 905, the smart contract 145 is recorded on the distributed ledger 148. The smart contract 145 can be recorded on the distributed ledger 148 as described with reference to 805.

At 907, the contract token is issued in accordance with the smart contract 145. The contract token can be issued as described with reference to 807 to 815.

At 909, a transaction request including a request for provision of a good and/or service in exchange for one or more contract tokens is received. The transaction request is received from the client system 120 over the communications network 160. The transaction request is received by the merchant system 110. The transaction request is a request from the client to exchange one or more contract tokens for the good and/or service offered by the merchant. The transaction request can be received, for example, by the client placing an order on a website hosted by the merchant. The website may be hosted on the merchant system 110.

At 911, the merchant wallet address is sent to the client. The merchant wallet address may be sent to the client system 120 over the communications network.

At 913, ownership of the contract token is transferred to the merchant wallet address. In particular, ownership of the contract token is transferred from the client system wallet address to the merchant wallet address. The client wallet 127 may generate a client digital signature. The client digital signature may be used to initialise a transaction on the distributed ledger 148 that transfers ownership of the contract token from the client system wallet address to the merchant wallet address. This transaction may be verified by the inclusion of the client digital signature. The transaction may be recorded on the digital ledger.

At 915, an authorization to provide the good and/or service is sent. The authorization can be sent to a user interface presented for a merchant employee, a merchant electronic device, and/or a merchant dispatch system that automatically actions provision of the good or service. In other examples, this authorisation is sent, at least in part, to the client system 120. This authorisation can be used by the client as proof to receive the good and/or service. For example, a product may include a vending machine and the client system 120 presents the authorisation to the vending machine to dispense a good.

In other examples, the merchant includes an unmanned store and the client device is a mobile communication device (e.g. smartphone, smartwatch, tablet device, or electronic wearable device). The authorization 915 can be sent to a merchant electronic device that operates doors or a gate to allow customers (associated with the client system 120) to enter and exit, or to release and dispense goods and/or services. In some examples, this includes the merchant electronic device confirming the presence of the client system 120 (e.g. a unique identifier of the client system, such as an IMEI) or the client (such as a name, account number, other personal identification, fingerprint, or other biometric identifier).

In further examples, the authorization 915 is also sent to the client system 120, whereby the merchant electronic device confirms the authorization at the client system 120 to release the goods. In some examples, this can include the client system 120 confirming the authorization at the client system, such as scanning a representation of the authorization on displayed on the client system (such as a touchscreen of a smartphone), or wirelessly communicating the authorization (or representation of the authorization) in a local communication network (such as WiFi or Bluetooth) or with near field communication technology.

### Computer-Implemented Method of Providing a Location Based Service

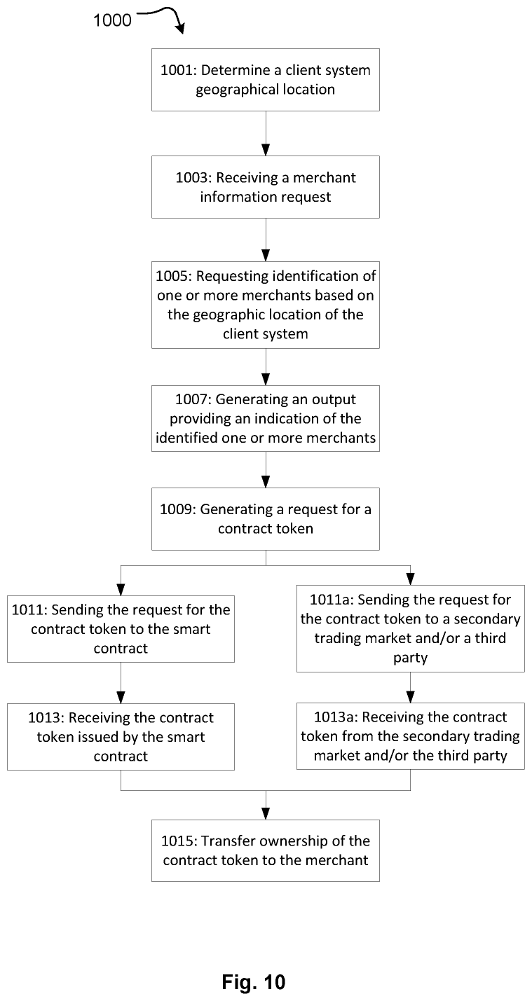

Referring now to FIG. 10, there is shown a process flow diagram of a computer-implemented method 1000 according to some embodiments. In some embodiments, the method 1000 is performed by the system 100 illustrated in FIG. 1, or one or more components or sub-systems of the system 100.

At 1001, a client system geographical location is determined. The client system geographical location may be determined using, for example, GPS triangulation or cell tower triangulation as previously described. Determining the client system geographical location may 120 include an authorisation step. That is, determining the location of the client system 120 may require authorisation of the client. This authorisation can be executed, for example by way of an input to the client system user interface 123.

At 1003, a merchant information request is received by the client system 120. The merchant information request may be received via the client system user interface 123.

At 1005, identification of one or more merchants based on at least one location based condition and the client system geographical location is requested. The identification of one or more merchants may be requested from a database. In some embodiments, the database may be the client database 128. In some embodiments, the database may be the merchant database 118. In some embodiments, the database may the distributed ledger 148. In some embodiments, the database may be the merchant information database 130.

In some embodiments, the at least one location based condition is a distance threshold. The location based condition may require identified merchants to be within a specified distance of the determined client system geographical location. That is, identified merchants are located within the distance threshold.

At 1007, an output providing an indication of the identified one or more merchants is generated. The output is displayed via the client system user interface 123. FIG. 11 shows an exemplary client system 120 (in the form of a smartphone) displaying the output via the client system user interface 123. In particular, the output may be provided via the client application interface 103. The output may include merchant information associated with the identified one or more merchants. For example, the output may include each merchant's name, address, distance from the client system geographical location and/or goods and/or services information associated with the merchant.

At 1009, a request for the contract token is generated. The request for the contract token may be generated as described with reference to 807.

In some embodiments, 1011 is executed. At 1011, the request for the contract token is sent by the client system 120. Sending the request for the contract token may be executed as described with reference to 809.

At 1013, the contract token is received. Receiving the contract token may comprise a transfer of ownership of the contract token from the smart contract 145 to the client system 120. The contract token may be received at the client wallet address. In other words, the contract token may be associated with the client wallet address. Thus, the contract token may be visible to, and accessible by the client wallet 127. Receiving the contract token may be executed as described with reference to 815.

In some embodiments, 1011a is executed. At 1011a, the request for the contract token is sent by the client system 120. In some embodiments, the request for the contract token is sent to the secondary trading market 150 and/or a third party. The request for the contract token may represent a request to purchase the contract token. The contract token may be purchased from the secondary trading market 150 itself (if the secondary trading market holds the contract tokens), or from a third party looking to exchange the secondary token on the secondary trading market 150, or independently. The third party may, for example, be the client system 120′. In some examples the request for the contract token via the secondary trading market 150 or a third party may include a premium to the cost. For example, at or close to the post-issuance ratio.

At 1013a, the contract token is received. Receiving the contract token may comprise a transfer of ownership of the contract token from the secondary trading market 150 or the client system 120′ to the client system 120. The contract token may be received at the client wallet address. In other words, the contract token may be associated with the client wallet address.

At 1015, ownership of the contract token is transferred to the merchant. Ownership of the contract token may be transferred to the merchant during a transaction with the merchant for a good and/or service. In some embodiments, ownership of the contract token may be transferred from the client wallet 127 to the merchant wallet 117.

In some embodiments, the method 1000 comprises receiving an execution input. The execution input may be provided by the client. The execution input may be provided via the client system user interface 123 and/or the client application interface 103. In some embodiments, receipt of the execution input initiates execution of 1001. In some embodiments, receipt of the execution input initiates execution of 1003. In these embodiments, 1001 may be executed passively. That is, the client system geographical location may be monitored consistently over time. This can improve the speed with which the method can be performed, by reducing the delay that would be inherent in having to determine the client system geographical location upon initiation of the method 1000.

In some embodiments, the method 1000 further comprises receiving a selection input. The selection input may be associated with a merchant of the identified one or more merchants. For example, the selection input may indicate that the client is interested in the goods and/or services of the respective merchant.

Method 1000 may advantageously reduce the computation resource requirements, data transmission requirements and bandwidth requirements of the client system 120, the merchant system 110 and/or the merchant information database 130. By requesting identification of one or more merchants based on the geographic location of the client system 120 and/or one or more other location-based conditions, context-specific results can be provided. That is, the identified one or more merchants are likely to be of interest to the client. For example, providing an indication of the one or more merchants within a geographical threshold of the client system 120 (and/or client) may be of more interest to the client than other merchants because of the relative ease with which the client may access the merchant's premises (if a physical premises). Furthermore, the provision of goods and/or services from the merchant may be realised more quickly due to identifying the one or more merchants based on the geographical location of the client system (or another location condition). For example, if the merchant is required to travel to the client to provide the good and/or service, or have the good and/or service delivered (for example in the mail), this may be achieved more quickly.

Improving the relevancy of the identified one or more merchants can result in the client and/or the client system 120 requesting merchant information less often. This can be because the client receives the relevant information at the first request, and therefore is less likely to need to make subsequent, follow up requests. Thus, the provision of the identified one or more merchants by the method 1000 reduces the bandwidth requirements and data transmission requirements of the client system 120 as less requests over the communications network 160 are made, and less identified merchants, and their associated merchant data, is communicated to the client device over the communications network 160. Furthermore, the computational requirements of the client system 120 are reduced, as the client system 120 is required to process less merchant information for display.

The provision of the identified one or more merchants by the method 1000 may also reduce the bandwidth, data transmission and computational requirements of the merchant system 110 for the same reasons (if the merchant information such as the merchant's geographical location is retrieved from the merchant system 110, as may be the case in some embodiments). The provision of the identified one or more merchants by the method 1000 may also reduce the bandwidth, data transmission and computational requirements of the merchant information database 130 for the same reasons (if the merchant information such as the merchant's geographical location is retrieved from the merchant information database 130, as may be the case in some embodiments).

### Client to Client and Client to Merchant Token Exchange

In some embodiments, the contract token may be exchanged between the client system 120 and the merchant system 110, and thus between the client and the merchant. That is, the client system 120 may be able to exchange the contract token under its control with the merchant system 110. In some embodiments, this may be done directly. That is, the client system 120 may transfer ownership of the contract token from the client wallet 127 to merchant wallet 117. In some embodiments, this may be executed by the client system 120 executing a transaction that is recorded on the distributed ledger 148 transferring ownership of the contract token. The merchant system 110 may also transfer ownership of the contract token from the merchant wallet 117 to the client wallet 127. In some embodiments, this may be executed by the merchant system 110 executing a transaction that is recorded on the distributed ledger 148 transferring ownership of the contract token from the merchant wallet 117 to the client wallet 127.

In some embodiments, the client system 120 may be able to exchange the contract token under its control with the merchant system 110 indirectly. For example, the secondary trading market 150 may facilitate the exchange between the client system 120 and the merchant system 110. The merchant system 110 (and/or the merchant) may place an order with the secondary trading market 150 indicating that the merchant system 110 (and/or the merchant) will acquire the contract token in exchange for a specified amount of a unit of account. The client system 120 may accept the order. This may constitute a transaction contract stored by the secondary trading market 150. Alternatively, the client system 120 (and/or the client) may place an order with the secondary trading market 150 indicating that the client system 120 (or the client) will transfer ownership of the contract token in exchange for a specified amount of a unit of account. The merchant system 110 (and/or the merchant) may accept the order. The client system 120 may then transfer ownership of the contract token to the merchant system 110. This may be done directly as described above. Alternatively, the client system 120 may transfer ownership of the contract token to the merchant system 110 using the secondary trading market 150 as the intermediary. For example, the client system 120 may transfer ownership of the contract token to the secondary trading market 150. The merchant system 110 may transfer ownership of the specified amount of the unit of account to the secondary trading market 150. The secondary trading market 150 may transfer ownership of the contract token to the merchant system 110, and ownership of the specified amount of the unit of the unit of account to the client system 120 after establishment of the transaction contract.

In some further examples, the system may allow client tokens to also be exchangeable between two or more client systems 120, 120′. That is, a first client system 120 may be able to exchange the contract token under its control with the second client system 120′. In some embodiments, this may be done directly. That is, the first client system 120 may transfer ownership of the contract token from the first client system's 120 client wallet 127 to the second client system's 120′ client wallet 127′. In some embodiments, this may be executed by the first client system 120 executing a transaction that is recorded on the distributed ledger 148 transferring ownership of the contract token from the first client system's 120 client wallet 127 to the second client system's 120′ client wallet 127′.

In some embodiments, the contract token may be exchanged between the first client system 120 and the second client system 120′ indirectly. This may be achieved as described previously with reference to the client system 120 and the merchant system 110 using the secondary trading market 150 to establish a transaction contract.

### Merchant Application Interface

Referring to FIG. 12, a portion of the merchant application interface 190 is shown. The merchant application interface 190 may comprise a plurality of parameter input portions 191. The parameter input portions 191 may facilitate the input of the one or more parameters by the merchant as previously described.

### Client Application Interface

Referring to FIG. 11, a portion of the client application interface 103 is shown. The client application interface 103 may comprise a search input portion 181. The search input portion 181 may be configured to be executed to receive a search query (e.g. a text input indicating a search the client would like to perform). Execution of the search input portion 181 may comprise receiving an input corresponding to the search input portion 181 by the client system 120. The search may comprise, for example, a complete, or a portion of a merchant name, a location and/or a good and/or service. The client application interface 103 may comprise a scan input portion 182. The scan input portion 182 may be configured to initiate a scan module by which the client system 120 may scan information. For example, the client system 120 may scan a credit card or a bar code.

The client application interface 103 may comprise a QR input portion 183. The QR input portion 183 may be configured to be executed initiate a QR scan software module by which the client system 120 may scan information, such as a QR code. Alternatively, the QR scan software module may generate for display information, such as a QR code. This QR code may represent the client wallet 127. Execution of the QR input portion 183 may comprise receiving an input corresponding to the QR input portion 183 by the client system 120.

The client application interface 103 may comprise a receive input portion 184. The receive input portion 184 may be configured to be executed to initiate a receiving application software module by which the client system 120 may receive a fiat currency, digital asset, financial asset and/or real asset. For example, the client system 120 may generate a QR code representing the client wallet 127. Execution of the receive input portion 184 may comprise receiving an input corresponding to the receive input portion 184 by the client system 120.

The client application interface 103 may comprise a bill input portion 185. The bill input portion 185 may be configured to be executed to initiate a bill software module by which the client system 120 may generate and display of a bill or transaction history. Execution of the bill software module may comprise receiving an input corresponding to the bill input portion 185 by the client system 120.

The client application interface 103 may comprise a merchant input portion 186. The merchant input portion 186 may provide a visual indication of merchant information for a particular merchant. The merchant input portion 186 may be configured to be executed to initiate a merchant visualisation software module by which the client system 120 may query and/or display additional merchant information. Execution of the merchant visualisation software module may comprise receiving an input corresponding to the merchant input portion 186 by the client system 120.

The client application interface 103 may comprise a balance input portion 187. The balance input portion 187 may be configured to be executed to initiate a balance software module by which the client system 120 may determine and display of a balance of the client wallet 127. Execution of the balance software module may comprise receiving an input corresponding to the balance input portion 186 by the client system 120.

The client application interface 103 may comprise a trade input portion 188. The trade input portion 188 may be configured to be executed to initiate a trade software module by which the client system 120 may initiate a trade of the contract token by the client as previously described. Execution of the trade software module may comprise receiving an input corresponding to the trade input portion 188 by the client system 120.

### Variations

In some embodiments, the smart contract 145 defines the conditions within which the contract token can be issued and/or traded. For example, in some embodiments, the contract token is freely issuable and tradeable. That is, any entity is free to be issued the contract token, and each owner of the contract token is free to trade the contract token with any other entity capable of receiving ownership of the contract token (e.g. an entity with a wallet for the distributed ledger 148).

In some embodiments, issue and/or trading of the contract token may be restricted. For example, trading of the contract token may be restricted based at least in part on the one or more location condition(s). In such embodiments, issue of the contract token may be restricted to a specific geographic location and/or region. For example, the contract token may only be issuable to client systems 120 in a particular city, country or defined geographical region.

In some embodiments, trading of the contract token may be restricted. For example, after issue, the contract token may only be exchangeable with the merchant. In other words, after issue, the client system 120 may only be able to exchange the contract token with the merchant system 110. To implement this, the smart contract 145 may, for example, restrict the transfer of ownership of the contract token after issue, except to one or more merchant wallets 117 and/or merchant wallet addresses.

Alternatively, in some embodiments, trading of the contract token may require approval of one or more approved entities. For example, the merchant and/or the secondary trading market 150 may be required to approve a transfer of ownership of the contract token.

In some embodiments, the smart contract 145 is generated by the merchant system 110. In particular, in some embodiments, the smart contract 145 is generated by the smart contract generation module 160 of the merchant system 110. In other embodiments, the one or more parameters received from the merchant at the merchant system 110 may be communicated to another system that generates the smart contract 145. For example, the merchant system 110 may communicate the one or more parameters to the distributed ledger system 140, which may generate the smart contract 145. Alternatively, the merchant system 110 may communicate the one or more parameters to the merchant information database 130. The merchant information database 130 may then generate the smart contract 145 using the one or more parameters. Alternatively, the merchant system 110 may communicate the one or more parameters to the secondary trading market 150. The secondary trading market 150 may generate the smart contract 145 using the one or more parameters.

Where steps of method 800, method 900 and/or method 1000 are performed by the merchant system 110, it should be understood that the steps could be performed by another computing device (on behalf of the merchant) if said other computing device comprises the merchant application 115, and provides the merchant application interface 190 to the merchant system 110 for data input.

Where steps of method 800, method 900 and/or method 1000 are performed by the client system 120, it should be understood that the steps could be performed by another computing device if said other computing device comprises the client application 125, and provides the client application interface 103 to the client system 120 for data input.

### Advantages

In addition to those described explicitly and implicitly above, embodiments of the present disclosure may have further advantages. Some embodiments advantageously allow merchants seeking to raise capital to, for example, fund continued operations, or develop, refine or provide a product or service may seek capital from a far wider audience. Any computing device running the client application 125 can participate in the funding ecosystem and exchange a unit of account for one or more contract tokens issued according to a smart contract established by the merchant.

Some embodiments allow for the provision of highly relevant goods and/or services to targeted audiences based on the determined client system geographic location. This can result in more transactions for the merchants, and more relevant and convenient merchant options being provided to the client. Some embodiments may therefore reduce the computational requirements, bandwidth requirements, data transmission requirements and/or storage requirements of one or more components or subsystems of the system 100, or another system implementing the relevant embodiment.

Some embodiments allow merchants to build a customer base, reward loyal clients with contract tokens and obtain merchant goods and/or services at preferential prices that are aligned with the merchant's interests. Concurrently, clients may be incentivised to provide recommendations of the merchants because of the value received by the client's improving the brand value of the merchant. Advantageously, the merchants may advertise their contract token, or the issuance of their contract token. The merchant is provided with the opportunity to increase their brand value further in this way.

Some embodiments allow clients to receive recommendations of nearby or local merchants. This can be based on the determined client system geographical location. These nearby or local merchants can be offering contract tokens providing beneficial goods and/or services to the client. These merchants may be recommended in real time, with the contract tokens being exchangeable in-store at the merchant's premises.

### Computing Machine Architecture

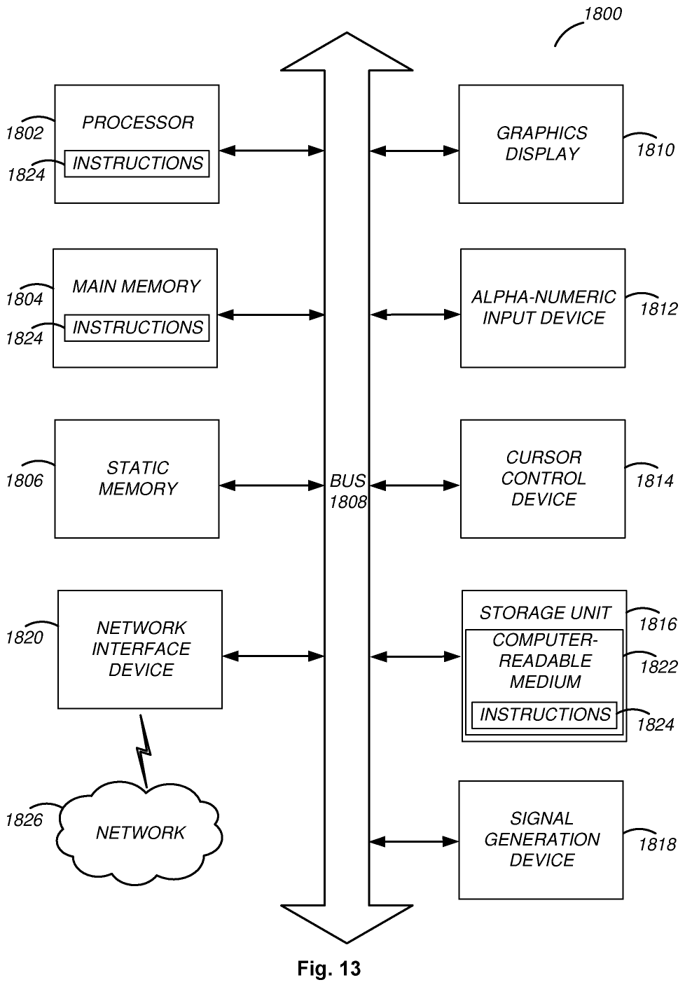

FIG. 13 is a block diagram illustrating components of an example computing machine that is capable of reading instructions from a computer-readable medium and execute them in a processor (or controller). A computer described herein may include a single computing machine shown in FIG. 13, a virtual machine, a distributed computing system that includes multiples nodes of computing machines shown in FIG. 13, or any other suitable arrangement of computing devices.

By way of example, FIG. 13 shows a diagrammatic representation of a computing machine in the example form of a computer system 1800 within which instructions 1824 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 13 may correspond to any software, hardware, or combined components shown in any of FIGS. 1 to 12, including but not limited to, the merchant system 110, the client system 120, the client system 120′, the secondary trading market 150, the communications network 160, the distributed ledger system 140 and/or the distributed ledger system 140′. While FIG. 13 shows various hardware and software elements, each of the components described in any of FIGS. 1 to 12 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1824 that specify actions to be taken by that machine. Further, while only a single machine is illustrated, the term “machine” shall also be taken to include any collection of machines that individually or jointly execute instructions 1824 to perform any one or more of the methodologies discussed herein.

The example computer system 1800 includes one or more processors (generally, processor 1802) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 1804, and a static memory 1806, which are configured to communicate with each other via a bus 1808. The computer system 1800 may further include graphics display unit 1810 (e.g., a plasma display panel (PDP), a liquid crystal display (LCD), a projector, or a cathode ray tube (CRT)). The computer system 1800 may also include alphanumeric input device 1812 (e.g., a keyboard), a cursor control device 1814 (e.g., a mouse, a trackball, a joystick, a motion sensor, or other pointing instrument), a storage unit 1816, a signal generation device 1818 (e.g., a speaker), and a network interface device 1820, which also are configured to communicate via the bus 1808.

The storage unit 816 includes a computer-readable medium 1822 on which is stored instructions 1824 embodying any one or more of the methodologies or functions described herein. The instructions 1824 may also reside, completely or at least partially, within the main memory 1804 or within the processor 1802 (e.g., within a processor's cache memory) during execution thereof by the computer system 1800, the main memory 1804 and the processor 1802 also constituting computer-readable media. The instructions 1824 may be transmitted or received over a network 1826 via the network interface device 1820.

While computer-readable medium 1822 is shown in an example embodiment to be a single medium, the term “computer-readable medium” should be taken to include a single medium or multiple media (e.g., a centralized or distributed database, or associated caches and servers) able to store instructions (e.g., instructions 1824). The computer-readable medium may include any medium that is capable of storing instructions (e.g., instructions 1824) for execution by the machine and that cause the machine to perform any one or more of the methodologies disclosed herein. The computer-readable medium may include, but not be limited to, data repositories in the form of solid-state memories, optical media, magnetic media, and a transitory medium such as a signal or a carrier wave.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer implemented method comprising:
receiving one or more parameters of a contract;
generating a smart contract representing the contract in accordance with the one or more parameters;
recording the smart contract on a distributed ledger;
receiving a request for a contract token; and
issuing the contract token in accordance with the smart contract, wherein the contract token is associated with a merchant, and wherein the one or more parameters are specified by the merchant.

2. The method of claim 1, wherein the contract token is associated with one or more location-based condition(s).

3. The method of either claim 1 or 2, wherein the one or more parameters relate to a number of the contract token to be issued, an issuance time of the contract token, an issuance price of the contract token, a minimum subscription quantity of the contract token at issue and/or a useable unit price of the contract token.

4. The method of any one of claims 1 to 3, wherein the contract token is issued in exchange for a transfer of ownership of a unit of account to the merchant at an issuance ratio.

5. The method of claim 4, wherein receiving the request for the contract token comprises the transfer of ownership of the unit of account to the merchant at the issuance ratio.

6. The method either claim 4 or 5, wherein receiving the request for the contract token comprises the transfer of ownership of a digital asset to a smart contract address associated with the smart contract recorded on the distributed ledger.

7. The method of any one of claims 4 to 6, wherein the issuance ratio corresponds to the ratio between an issuance quantity of the contract token that is issued per base unit of the unit of account at a first time.

8. The method of claim 7 when dependent on claim 3, wherein the first time is indexed to the issuance time.

9. The method of claim 7, wherein the first time is the time at which the transfer of ownership of the unit of account to the merchant or the smart contract address is executed.

10. The method of any one of claims 4 to 9, wherein the contract token is exchangeable, after issuance, with the merchant at a post-issuance ratio.

11. The method of claim 10 when dependent on claim 7, wherein the post-issuance ratio corresponds to an exchangeable quantity of the contract token, the exchangeable quantity being exchangeable with the merchant for goods and/or services valued at the base unit of the unit of account at a second time, the second time being after the first time.

12. The method of claim 10 or claim 11, wherein the issuance ratio is greater than the post-issuance ratio.

13. The method of any one of claims 10 to 12, wherein the one or more location-based conditions comprises a restriction on the exchange of the contract token with the merchant at the post-issuance ratio to one or more specified merchant location(s).

14. The method any one of claims 4 to 13, wherein the unit of account is a fiat currency, a digital asset, a financial asset or a real asset.

15. The method of claim 2 to 14, wherein at least part of the location-based condition(s) is published on the distributed ledger.

16. The method of any one of claims 1 to 15, wherein the distributed ledger is a public distributed ledger, a private distributed ledger, a permissionless distributed ledger and/or a permissioned distributed ledger.

17. The method of any one of claims 1 to 16, wherein the steps of receiving one or more parameters of a contract, generating a smart contract representing the contract in accordance with the one or more parameters, and recording the smart contract on a distributed ledger are executed by a merchant system.

18. A computer-readable storage medium storing instructions that, when executed by a computer, cause the computer to perform the method of any one of claims 1 to 17.

19. A system comprising:
a merchant system associated with a merchant comprising;
at least one merchant system processor; and
a merchant system memory storing merchant system program code accessible by the at least one merchant system processor, and configured to cause the at least one merchant system processor to:
receive one or more parameters of a contract;
generate a smart contract representing the contract in accordance with the one or more parameters; and
record the smart contract on a distributed ledger; and
a client system associated with a client comprising;
at least one client system processor; and
a client system memory storing client system program code accessible by the at least one client system processor, and configured to cause the at least one client system processor to:
generate a request for a contract token;
send the request for the contract token the smart contract recorded on the distributed ledger; and
receive the contract token issued by the smart contract in accordance with the one or more parameters.

20. The system of claim 19, wherein the contract token is associated with one or more location-based condition(s).

21. The system of either claim 19 or 20, wherein the one or more parameters relate to a number of the contract token to be issued, an issuance time of the contract token, an issuance price of the contract token, a minimum subscription quantity of the contract token at issue and/or a useable unit price of the contract token.

22. The system of any one of claims 19 to 21, further comprising a distributed ledger system comprising:
at least one distributed ledger system processor; and
a distributed ledger system memory storing distributed ledger system program code, the distributed ledger and the smart contract, the smart contract being accessible by the at least one distributed ledger system processor, and configured to cause the at least one distributed ledger system processor to:
receive the request for the contract token; and
issue the contract token in accordance with the smart contract.

23. The system of claim 22, wherein the contract token is issued in exchange for a transfer of ownership of a unit of account to the merchant at an issuance ratio.

24. The system claim 23, wherein receiving the request for the contract token comprises the transfer of ownership of the unit of account to the merchant at the issuance ratio.

25. The system of claim 23 or 24, wherein receiving the request for the contract token comprises the transfer of ownership of a digital asset to a smart contract address or a merchant wallet address associated with the smart contract recorded on the distributed ledger.

26. The system of claim 23 to 25, wherein the issuance ratio corresponds to the ratio between an issuance quantity of the contract token that is issued per base unit of the unit of account at a first time.

27. The system of claim 26 when dependent on claim 21, wherein the first time is indexed to the issuance time.

28. The system of claim 26, wherein the first time is the time at which the transfer of ownership of the unit of account to the merchant or the smart contract address is executed.

29. The system of any one of claims 23 to 28, wherein the contract token is exchangeable, after issuance, with the merchant at a post-issuance ratio.

30. The system of claim 29, wherein the post-issuance ratio corresponds to an exchangeable quantity of the contract token, the exchangeable quantity being exchangeable with the merchant for goods and/or services valued at the base unit of the unit of account at a second time, the second time being after the first time.

31. The system of claim 28 or claim 29, wherein the issuance ratio is greater than the post-issuance ratio.

32. The system of any one of claims 29 to 31, wherein the one or more location-based conditions comprise a restriction on the exchange of the contract token with the merchant at the post-issuance ratio to one or more specified merchant location.

33. The system of any one of claims 23 to 32, wherein the unit of account is a fiat currency, a digital asset, a financial asset or a real asset.

34. The system of any one of claims 20 to 33, wherein at least part of the location-based condition(s) is published on the distributed ledger.

35. The system of any one of claims 19 to 34, wherein the distributed ledger is a public distributed ledger, a private distributed ledger, a permissionless distributed ledger and/or a permissioned distributed ledger.

36. The system of any one of claims 19 to 35, wherein the merchant system comprises a merchant system user interface, and wherein the merchant system is configured to receive an input via the merchant system user interface, the input comprising instructions indicative of the one or more parameters.

37. A client system comprising;
at least one client system processor; and
a client system memory storing client system program code accessible by the at least one client system processor, and configured to cause the at least one client system processor to:
determine a geographic location of the client system;
request, from a database, identification of one or more merchants, based on location-based condition(s) of the one or more merchants in the database and the geographic location of the client system; and
generate an output, the output providing an indication of the identified one or more merchants.

38. The client system of claim 37, comprising a client system user interface, wherein the client system program code is further configured to cause the at least one client system processor to display the output via the client system user interface.

39. The client system of claim 38, wherein the client system is configured to receive an input via the client system user interface, the input comprising instructions to execute the request.

40. The client system of any one of claims 37 to 39, wherein the client system comprises a client system database, and the database is, at least in part, the client system database.

41. The client system of any one of claims 37 to 40, wherein the database is, at least in part, a merchant system database.

42. The client system of any one of claims 38 to 41, wherein the database is at least one node of a distributed ledger.

43. The client system of any one of claims 37 to 42, wherein the client system program code is further configured to cause the at least one client system processor to:
generate a request for a contract token;
send the request for the contract token to a smart contract or to a secondary trading market; and
receive the contract token, wherein the contract token is associated with at least one merchant and one or more parameters specified by the at least one merchant.

44. The client system of claim 43, further comprising a client system wallet, wherein the client system program code is further configured to cause the at least one client system processor to receive the contract token at the client system wallet.

45. The client system of either claim 43 or 44, wherein receiving the contract token comprises a transfer of ownership of the contract token from a first entity to the client system.

46. The client system of any one of claims 37 to 45, wherein the client system program code is further configured to cause the at least one client system processor to transfer ownership of the contract token to the merchant during a transaction with the merchant for a good and/or service.

47. A system according to any one of claims 19 to 36 wherein the client system comprises the client system of any one of claims 37 to 46.

48. A merchant system comprising:
at least one merchant system processor; and
a merchant system memory storing merchant system program code accessible by the at least one merchant system processor, and configured to cause the at least one merchant system processor to:
receive one or more parameters characterising a contract;
generate a smart contract representing the contract in accordance with the one or more parameters;
record the smart contract on a distributed ledger to issue one or more contract tokens associated with the merchant and in accordance with the one or more parameters in the contract;
receive, from a client system, a transaction request wherein the transaction request includes a request for provision of a good and/or service from the merchant in exchange for one or more contract token as payment;
send, to the client system, a merchant wallet address associated with the merchant to facilitate transfer of ownership of the one or more contract tokens to the merchant; and
based on verification that the contract token is transferred to the merchant wallet address, send an authorization to provide the good and/or service for the transaction.
